(19) United States
(12) Patent Application Publication
(10) Pub. No.: US 2019/0188623 A1
(43) Pub. Date: Jun. 20, 2019

(54) COGNITIVE AND DYNAMIC BUSINESS PROCESS GENERATION

(71) Applicant: International Business Machines Corporation, Armonk, NY (US)

(72) Inventors: Deepak Sekar, Como (AU); Salil Ahuja, Southbank (AU); Debojyoti Mookerjee, Wahroonga (AU); William J. Shondelmyer, Thorndon (NZ)

(21) Appl. No.: 15/841,413

(22) Filed: Dec. 14, 2017

(51) Int. Cl. G06Q 10/06; G06N 5/02

(52) U.S. Cl. CPC G06Q 10/06375; G06N 5/02

(57) ABSTRACT

In an approach for providing a cognitive and dynamic business process, based on a user's natural language input, a processor receives information from a user, wherein the information includes natural language input. A processor analyzes the information from the user, using natural language processing. A processor generates a cognitive and dynamic business process, wherein the cognitive and dynamic business process assists the user to determine a solution to a problem. A processor delivers the cognitive and dynamic business process, wherein the delivered cognitive and dynamic business process includes a request for feedback. A processor analyzes the feedback, wherein the cognitive and dynamic business process is tagged with the feedback and stored, and wherein the feedback is based on feedback from the user and a subject matter expert.

### BACKGROUND

The present invention relates generally to the field of business processes, and more particularly to providing a cognitive and dynamic business process, based on a user's natural language input.

A business process is a collection of related, structured activities or tasks that produce specific service or product for customers.

Natural language processing is concerned with the interactions between computers and human (i.e., natural) languages, and in particular, concerned with programming computers to effectively process large natural language corpora.

### SUMMARY

Aspects of an embodiment of the present invention disclose a method, computer program product, and computing system for providing a cognitive and dynamic business process, based on a user's natural language input. A processor receives information from a user, wherein the information includes natural language input. A processor analyzes the information from the user, using natural language processing. A processor generates a cognitive and dynamic business process, wherein the cognitive and dynamic business process assists the user to determine a solution to a problem. A processor delivers the cognitive and dynamic business process, wherein the delivered cognitive and dynamic business process includes a request for feedback. A processor analyzes the feedback, wherein the cognitive and dynamic business process is tagged with the feedback and stored, and wherein the feedback is based on feedback from the user and a subject matter expert.

### BRIEF DESCRIPTION OF THE DRAWINGS

FIG. 1 depicts a block diagram of a computing system, in accordance with an embodiment of the present invention.

FIG. 2 depicts a flowchart of the steps of a generation program, executing within the computing system of FIG. 1, for providing a cognitive and dynamic business process, based on a user's natural language input.

FIG. 3 depicts a block diagram of components of the server and/or the computing devices of FIG. 1, in accordance with an embodiment of the present invention.

### DETAILED DESCRIPTION

Embodiments of the present invention recognize that business processes are usually structured and fixed, typically having a one size fits all approach (e.g., resetting a password, buying tickets, and getting repairs for home appliances). Embodiments of the present invention recognize there is a problem of a lack of understanding of individual needs and forcing users (e.g., customers, staff, suppliers, etc.) to go through the fixed processes that leads to user dissatisfaction, process abandonment, and churn, amongst other negative outcomes. Embodiments of the present invention recognize the proposed solution will dramatically change the approach to business process engineering, rules generation and management, system design, and user experiences.

Embodiments of the present invention leverage natural language processing with a predefined set of sub-processes that use cognitive capabilities, like, language, sentiment, and tone to create a dynamic process on the fly that is specific to each individual customer's needs, based on the customer's initial explanation of a problem. Embodiments of the present invention will not have customers be pushed through interactive voice response menu flows or customer service representatives with no experience. Instead, the customer can type or speak issues and based on the specific issues, embodiments of the present invention will generate a process flow specific to the customer's needs, wherein the business flow can be a combination of subject matter experts, forms, paperwork, etc.

Embodiments of the present invention disclose an approach to provide a real-time cognitive, dynamic, and personalized business process, based on a user's natural language input and enhanced based on feedback.

Embodiments of the present invention will now be described in detail with reference to the Figures.

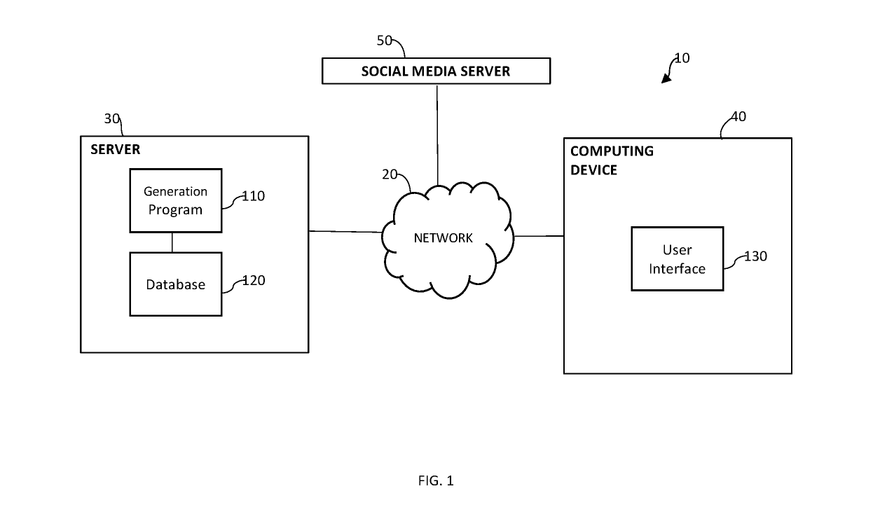

FIG. 1 depicts a block diagram of computing system 10, in accordance with one embodiment of the present invention. FIG. 1 provides an illustration of one embodiment and does not imply any limitations with regard to the environments in which different embodiments may be implemented.

In the depicted embodiment, computing system 10 includes server 30, computing device 40, and social media server 50 interconnected over network 20. Network 20 may be a local area network (LAN), a wide area network (WAN) such as the Internet, a cellular data network, any combination thereof, or any combination of connections and protocols that will support communications between server 30, computing device 40, and social media server 50, in accordance with embodiments of the invention. Network 20 may include wired, wireless, or fiber optic connections. Computing system 10 may include additional computing devices, servers, or other devices not shown.

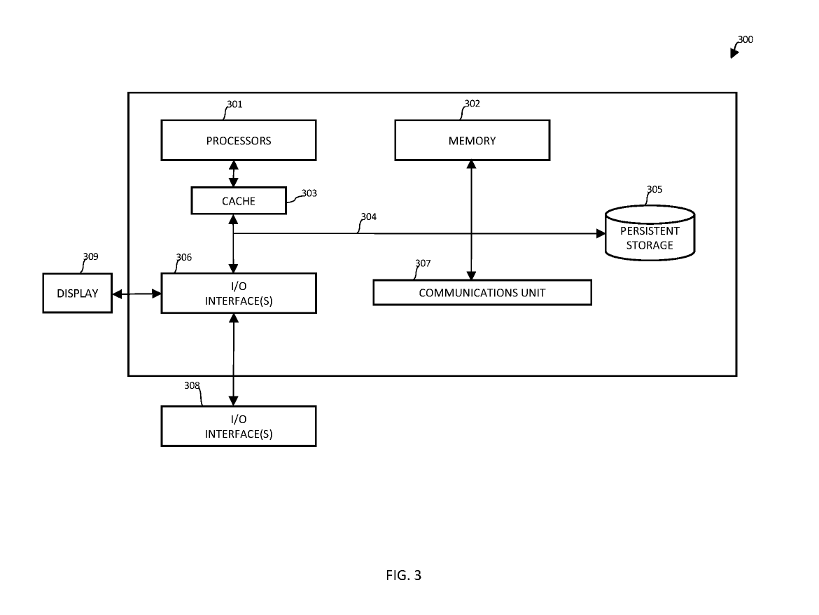

Server 30 may be a management server, a web server, or any other electronic device or computing system capable of processing program instructions and receiving and sending data. In some embodiments, server 30 may be a laptop computer, tablet computer, netbook computer, personal computer (PC), a desktop computer, or any programmable electronic device capable of communicating with computing device 40 via network 20. In other embodiments, server 30 may represent a server computing system utilizing multiple computers as a server system, such as in a cloud computing environment. In another embodiment, server 30 represents a computing system utilizing clustered computers and components to act as a single pool of seamless resources. In the depicted embodiment, server 30 contains generation program 110 and database 120. In other embodiments, server 30 may include generation program 110, database 120, and/or other components, as depicted and described in further detail with respect to FIG. 3.

Computing device 40 may be a personal device, desktop computer, laptop computer, netbook computer, tablet computer, management server, web server, or application server. In general, computing device 40 may be any electronic device or computing system capable of processing program instructions, sending and receiving data, and communicating with other devices over a network. In the depicted embodiment, computing device 40 contains user interface 130. In other embodiments, computing device 40 may include user interface 130 and/or other components, as depicted and described in further detail with respect to FIG. 3.

Social media server 50 may be a management server, a web server, or any other electronic device or computing system capable of processing program instructions and receiving and sending data. In some embodiments, social media server 50 may be a laptop computer, tablet computer, netbook computer, personal computer (PC), a desktop computer, or any programmable electronic device capable of communicating with server 30 and computing device 40 via network 20. In other embodiments, social media sever 50 may represent a server computing system utilizing multiple computers as a server system, such as in a cloud computing environment. In another embodiment, social media sever 50 represents a computing system utilizing clustered computers and components to act as a single pool of seamless resources. In one embodiment, social media server 50 contains information, such as, for example, expressions of interest from various social media websites. In other embodiments, social media server 50 hosts a social networking website. In some embodiments, social media server 50 is a social media platform. In other embodiments, social media server 50 may include multiple components, as depicted and described in further detail with respect to FIG. 3.

Generation program 110 provides a cognitive and dynamic business process, based on a user's natural language input. In doing so, generation program 110 receives customer information. Generation program 110 analyzes the customer information. Generation program 110 generates a cognitive and dynamic business process. Generation program 110 delivers the cognitive and dynamic business process. Generation program 110 analyzes feedback. In the depicted embodiment, generation program 110 resides on server 30. In other embodiments, generation program 110 may reside on another server, computing device 40, or another computing device, provided that generation program 110 can access database 120 and user interface 130.

Database 120 may be a repository that may be written to and/or read by generation program 110. In some embodiments, generation program 110 may map the intents and entities with metadata associated with sub-business processes and store the mapped intents and entities with metadata associated with sub-business processes to database 120. In other embodiments, database 120 may store previous successful sub-business processes. In the depicted embodiment, database 120 resides on server 30. In other embodiments, database 120 may reside on another server, computing device 40, or another computing device, provided that database 120 is accessible to generation program 110.

User interface 130 may be any user interface used to access information from server 30, such as information gathered or produced by generation program 110. In some embodiments, user interface 130 may be a generic web browser used to retrieve, present, and negotiate information resources from the Internet. In other embodiments, user interface 130 may be a software program or application that enables a user at computing device 40 to access server 30 over network 20. In the depicted embodiment, user interface 130 resides on computing device 40. In other embodiments, user interface 130 may reside on another computing device or another server, provided that user interface 130 is accessible to generation program 110.

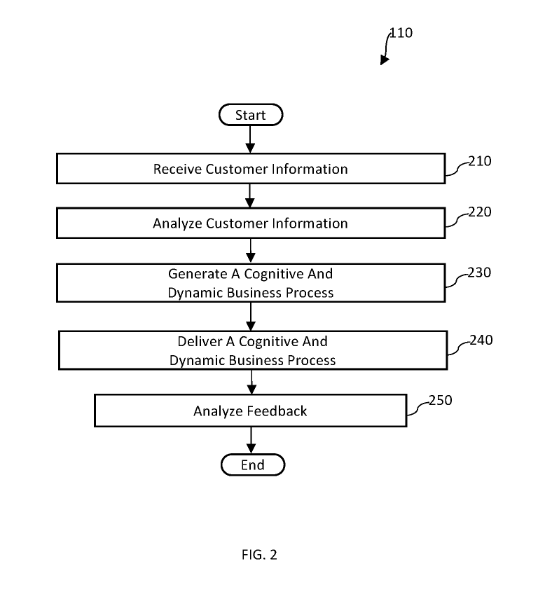

FIG. 2 depicts a flowchart of the steps of a generation program, executing within the computing system of FIG. 1, in accordance with an embodiment of the present invention. Generation program 110 provides a cognitive and dynamic business process, based on a user's natural language input.

In step 210, generation program 110 receives customer information. In one embodiment, generation program 110 receives customer information from a user through user interface 130. In some embodiments, generation program 110 receives customer information from a user through a mobile phone by voice or text. If by voice, generation program 110 may convert the voice to text for natural language processing purposes. In other embodiments, generation program 110 retrieves customer information from social media server 50.

Customer information is any information that a user may send to generation program 110 to be used as a natural language input. Customer information may include, but not limited to: customer complaint; customer question; entity requiring attention; customer identifying information (e.g., name, age, geographic location, etc.); relevant topic; social media analytics; etc.

An example of what a user may say is: I did recharge for $50, and I am not able to see the same; this is frustrating.

In step 220, generation program 110 analyzes the customer information. In one embodiment, generation program 110 identifies intents, entities, tones, and preferences from the natural language input from the user. In some embodiments, generation program 110 determines the intent, entity, tone, and preference of the user by, for example, analyzing information from a customer profile found in database 120, the natural language input, and customer social media analytics from the user's social media accounts found on social media server 50. The customer social media analytics may reveal that the user has tweeted about the network issues in the recent past. The customer profile may reveal how long the user has been a customer in the network (e.g., over ten years).

In other embodiments, generation program 110 maps the intents and entities with metadata associated with sub-business processes, wherein sub-business processes are previous processes that were stored to database 120 that were determined to be successful for a particular topic or problem.

The analysis of the example of what the user said above may be determined that the user's tone is anger, and the user's problem is a recharge.

In step 230, generation program 110 generates a cognitive and dynamic business process. In one embodiment, generation program 110 searches database 120 for any previous sub-business processes that may have been used for a combination similar to the above combination of the user's tone and problem. If generation program 110 finds such a sub-business process available in database 120, then generation program 110 uses the sub-business process as a part of the generated cognitive and dynamic business process. In other embodiments, generation program 110 identifies a customer service representative eligible to handle such a combination of the user's tone and problem by searching database 120 for any customer service representative tagged with any labels that may show that the customer service representative has expertise dealing with such a combination of tone and problem. Initially, information about customer service representatives are tagged with various labels showing various expertise and stored in database 120 for future use. If generation program 110 finds, from database 120, that such a customer service representative available, then generation program 110 contacts the customer service representative and uses the customer service representative as part of the generated cognitive and dynamic business process.

In some embodiments, generation program 110 uses the analyzed user's natural language input, information from the customer profile, customer social media analytics, and the determined intent, entity, tone, and preference as a part of the generated cognitive and dynamic business process. The business process is used to assist the customer and define a solution.

In step 240, generation program 110 delivers the cognitive and dynamic business process. In one embodiment, generation program 110 delivers the cognitive and dynamic business process to the user in the form of a customer service representative, who is a subject matter expert in the matter at hand. In some embodiments, generation program 110 delivers the cognitive and dynamic business process to the user in the form of forms or paperwork, guiding the user to a solution for the matter at hand. In other embodiments, generation program 110 delivers the cognitive and dynamic business process to the user in the form of a combination of a subject matter expert and forms/paperwork, guiding the user to a solution for the matter at hand. Still, in some embodiments, generation program 110 includes a request for customer feedback. Generation program 110 may request customer feedback using a survey (text or voice), an email, text, return phone call, or any other means of allowing the customer to relay the customer's feedback on the business process and solution presented therein.

In step 250, generation program 110 analyzes feedback. In one embodiment, generation program 110 receives no feedback, and generation program 110 ends. In some embodiments, generation program 110 receives negative feedback and analyzes the negative feedback. The feedback may be negative for any number of reasons, including: bad solution; bad customer service; too much time involved in the process; etc. In some embodiments, generation program 110 requests and receives expert analysis as to why the business process flow received negative feedback and did not solve the problem. In some embodiments, generation program 110 tags the business process flow used and stores the tagged business process flow to database 120 for future use. The rendered business process flow is enhanced based on customer and/or expert feedback, thereby providing a better customer experience after each rendition.

In other embodiments, generation program 110 receives positive feedback and analyzes the positive feedback. The feedback may be positive for any number of reasons, including: good solution; good customer service; speedy and efficient process; etc. In some embodiments, generation program 110 requests and receives expert analysis as to why the business process flow received positive feedback and solved the problem. In some embodiments, generation program 110 tags the business process flow used and stores the tagged business process flow to database 120 for future use. The rendered business process flow is enhanced based on customer and/or expert feedback, thereby providing a better customer experience after each rendition.

FIG. 3 depicts computer system 300, which is an example of a system that includes components of server 30 and/or computing device 40. Computer system 300 includes processors 301, cache 303, memory 302, persistent storage 305, communications unit 307, input/output (I/O) interface(s) 306 and communications fabric 304. Communications fabric 304 provides communications between cache 303, memory 302, persistent storage 305, communications unit 307, and input/output (I/O) interface(s) 306. Communications fabric 304 can be implemented with any architecture designed for passing data and/or control information between processors (such as microprocessors, communications and network processors, etc.), system memory, peripheral devices, and any other hardware components within a system. For example, communications fabric 304 can be implemented with one or more buses or a crossbar switch.

Memory 302 and persistent storage 305 are computer readable storage media. In this embodiment, memory 302 includes random access memory (RAM). In general, memory 302 can include any suitable volatile or non-volatile computer readable storage media. Cache 303 is a fast memory that enhances the performance of processors 301 by holding recently accessed data, and data near recently accessed data, from memory 302.

Program instructions and data used to practice embodiments of the present invention may be stored in persistent storage 305 and in memory 302 for execution by one or more of the respective processors 301 via cache 303. In an embodiment, persistent storage 305 includes a magnetic hard disk drive. Alternatively, or in addition to a magnetic hard disk drive, persistent storage 305 can include a solid state hard drive, a semiconductor storage device, read-only memory (ROM), erasable programmable read-only memory (EPROM), flash memory, or any other computer readable storage media that is capable of storing program instructions or digital information.

The media used by persistent storage 305 may also be removable. For example, a removable hard drive may be used for persistent storage 305. Other examples include optical and magnetic disks, thumb drives, and smart cards that are inserted into a drive for transfer onto another computer readable storage medium that is also part of persistent storage 305.

Communications unit 307, in these examples, provides for communications with other data processing systems or devices. In these examples, communications unit 307 includes one or more network interface cards. Communications unit 307 may provide communications through the use of either or both physical and wireless communications links. Program instructions and data used to practice embodiments of the present invention may be downloaded to persistent storage 305 through communications unit 307. Generation program 110 and database 120 may be downloaded to persistent storage 305 of server 30 through communications unit 307 of server 30. User interface 130 may be downloaded to persistent storage 305 of computing device 40 through communications unit 307 of computing device 40.

I/O interface(s) 306 allows for input and output of data with other devices that may be connected to each computer system. For example, I/O interface 306 may provide a connection to external devices 308 such as a keyboard, keypad, a touch screen, and/or some other suitable input device. External devices 308 can also include portable computer readable storage media such as, for example, thumb drives, portable optical or magnetic disks, and memory cards. Software and data used to practice embodiments of the present invention, e.g., generation program 110 and database 120, can be stored on such portable computer readable storage media and can be loaded onto persistent storage 305 of server 30 via I/O interface(s) 306 of server 30. Software and data used to practice embodiments of the present invention, e.g., user interface 130, can be stored on such portable computer readable storage media and can be loaded onto persistent storage 305 of computing device 40 via I/O interface(s) 306 of computing device 40. I/O interface(s) 306 also connect to display 309.

Display 309 provides a mechanism to display data to a user and may be, for example, a computer monitor.

The programs described herein are identified based upon the application for which they are implemented in a specific embodiment of the invention. However, it should be appreciated that any particular program nomenclature herein is used merely for convenience, and thus the invention should not be limited to use solely in any specific application identified and/or implied by such nomenclature.

The present invention may be a system, a method, and/or a computer program product. The computer program product may include a computer readable storage medium (or media) having computer readable program instructions thereon for causing a processor to carry out aspects of the present invention.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, or either source code or object code written in any combination of one or more programming languages, including an object oriented programming language such as Smalltalk, C++ or the like, and conventional procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the block may occur out of the order noted in the Figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

The descriptions of the various embodiments of the present invention have been presented for purposes of illustration, but are not intended to be exhaustive or limited to the embodiments disclosed. Many modifications and variations will be apparent to those of ordinary skill in the art without departing from the scope and spirit of the invention. The terminology used herein was chosen to best explain the principles of the embodiment, the practical application or technical improvement over technologies found in the marketplace, or to enable others of ordinary skill in the art to understand the embodiments disclosed herein.

What is claimed is:

1. A method comprising:
receiving, by one or more processors, information from a user, wherein the information includes natural language input;
analyzing, by one or more processors, the information from the user, using natural language processing;
generating, by one or more processors, a cognitive and dynamic business process, wherein the cognitive and dynamic business process assists the user to determine a solution to a problem;
delivering, by one or more processors, the cognitive and dynamic business process, wherein the delivered cognitive and dynamic business process includes a request for feedback; and
subsequent to receiving the feedback, analyzing, by one or more processors, the feedback, wherein the cognitive and dynamic business process is tagged with the feedback and stored, and wherein the feedback is based on feedback from the user and a subject matter expert.

2. The method of claim 1, wherein the information includes user complaints, user questions, entities requiring attention, user identifying information, relevant topics, and social media analytics.

3. The method of claim 1, further comprising:
identifying, by one or more processors, intents, entities, tones, and preferences; and
mapping, by one or more processors, the intents and the entities with metadata associated with sub-business processes, wherein the sub-business processes are previous business processes that were stored for future use that were determined to be successful for a particular topic and problem.

4. The method of claim 3, further comprising:
identifying, by one or more processors, a customer service representative within a database tagged with metadata that shows the customer service representative has expertise dealing with a combination of the user's tone and problem; and
contacting, by one or more processors, the customer service representative to be used as part of the cognitive and dynamic business process to assist the user.

5. The method of claim 4, wherein delivering the cognitive and dynamic business process comprises:
delivering, by one or more processors, the cognitive and dynamic business process to the user in the form of a combination of the customer service representative and paperwork, guiding the user to a solution.

6. The method of claim 1, further comprising:
receiving, by one or more processors, negative feedback from the user;
analyzing, by one or more processors, the negative feedback;
requesting, by one or more processors, from the subject matter expert, analysis of the feedback as to why the negative feedback from the user was received and did not solve the problem; and
receiving, by one or more processors, the analysis of the feedback from the subject matter expert.

7. The method of claim 1, wherein the information is received from the user through voice and converted to text for natural language processing purposes.

8. A computer program product comprising:
one or more computer readable storage media and program instructions stored on the one or more computer readable storage media, the program instructions comprising:
program instructions to receive information from a user, wherein the information includes natural language input;
program instructions to analyze the information from the user, using natural language processing;
program instructions to generate a cognitive and dynamic business process, wherein the cognitive and dynamic business process assists the user to determine a solution to a problem;
program instructions to deliver the cognitive and dynamic business process, wherein the delivered cognitive and dynamic business process includes a request for feedback; and
subsequent to receiving the feedback, program instructions to analyze the feedback, wherein the cognitive and dynamic business process is tagged with the feedback and stored, and wherein the feedback is based on feedback from the user and a subject matter expert.

9. The computer program product of claim 8, wherein the information includes user complaints, user questions, entities requiring attention, user identifying information, relevant topics, and social media analytics.

10. The computer program product of claim 8, further comprising:
program instructions, stored on the one or more computer readable storage media, to identify intents, entities, tones, and preferences; and
program instructions, stored on the one or more computer readable storage media, to map the intents and the entities with metadata associated with sub-business processes, wherein the sub-business processes are previous business processes that were stored for future use that were determined to be successful for a particular topic and problem.

11. The computer program product of claim 10, further comprising:
program instructions, stored on the one or more computer readable storage media, to identify a customer service representative within a database tagged with metadata that shows the customer service representative has expertise dealing with a combination of the user's tone and problem; and
program instructions, stored on the one or more computer readable storage media, to contact the customer service representative to be used as part of the cognitive and dynamic business process to assist the user.

12. The computer program product of claim 11, wherein program instructions to deliver the cognitive and dynamic business process comprises:
program instructions to deliver the cognitive and dynamic business process to the user in the form of a combination of the customer service representative and paperwork, guiding the user to a solution.

13. The computer program product of claim 8, further comprising:
program instructions, stored on the one or more computer readable storage media, to receive negative feedback from the user;
program instructions, stored on the one or more computer readable storage media, to analyze the negative feedback;
program instructions, stored on the one or more computer readable storage media, to request, from the subject matter expert, analysis of the feedback as to why the negative feedback from the user was received and did not solve the problem; and
program instructions, stored on the one or more computer readable storage media, to receive the analysis of the feedback from the subject matter expert.

14. The computer program product of claim 8, wherein the information is received from the user through voice and converted to text for natural language processing purposes.

15. A computer system comprising:
one or more computer processors, one or more computer readable storage media, and program instructions stored on the one or more computer readable storage media for execution by at least one of the one or more computer processors, the program instructions comprising:
program instructions to receive information from a user, wherein the information includes natural language input;
program instructions to analyze the information from the user, using natural language processing;
program instructions to generate a cognitive and dynamic business process, wherein the cognitive and dynamic business process assists the user to determine a solution to a problem;
program instructions to deliver the cognitive and dynamic business process, wherein the delivered cognitive and dynamic business process includes a request for feedback; and
subsequent to receiving the feedback, program instructions to analyze the feedback, wherein the cognitive and dynamic business process is tagged with the feedback and stored, and wherein the feedback is based on feedback from the user and a subject matter expert.

16. The computer system of claim 15, wherein the information includes user complaints, user questions, entities requiring attention, user identifying information, relevant topics, and social media analytics.

17. The computer system of claim 15, further comprising:
program instructions, stored on the one or more computer readable storage media for execution by at least one of the one or more computer processors, to identify intents, entities, tones, and preferences; and
program instructions, stored on the one or more computer readable storage media for execution by at least one of the one or more computer processors, to map the intents and the entities with metadata associated with sub-business processes, wherein the sub-business processes are previous business processes that were stored for future use that were determined to be successful for a particular topic and problem.

18. The computer system of claim 17, further comprising:
program instructions, stored on the one or more computer readable storage media for execution by at least one of the one or more computer processors, to identify a customer service representative within a database tagged with metadata that shows the customer service representative has expertise dealing with a combination of the user's tone and problem; and
program instructions, stored on the one or more computer readable storage media for execution by at least one of the one or more computer processors, to contact the customer service representative to be used as part of the cognitive and dynamic business process to assist the user.

19. The computer system of claim 18, wherein program instructions to deliver the cognitive and dynamic business process comprises:
program instructions to deliver the cognitive and dynamic business process to the user in the form of a combination of the customer service representative and paperwork, guiding the user to a solution.

20. The computer system of claim 15, further comprising:
program instructions, stored on the one or more computer readable storage media for execution by at least one of the one or more computer processors, to receive negative feedback from the user;
program instructions, stored on the one or more computer readable storage media for execution by at least one of the one or more computer processors, to analyze the negative feedback;
program instructions, stored on the one or more computer readable storage media for execution by at least one of the one or more computer processors, to request, from the subject matter expert, analysis of the feedback as to why the negative feedback from the user was received and did not solve the problem; and
program instructions, stored on the one or more computer readable storage media for execution by at least one of the one or more computer processors, to receive the analysis of the feedback from the subject matter expert.
